(19) United States
(12) Patent Application Publication
(10) Pub. No.: US 2015/0168566 A1
(43) Pub. Date: Jun. 18, 2015

(54) Portable Radiographic Imaging Apparatus And Radiographic Imaging System

(71) Applicant: KONICA MINOLTA, INC., Chiyoda-ku (JP)

(72) Inventors: Atsunori SHIKINO, Tsuzuki-ku (JP); Tetsuo KUBOTA, Kokubunji-shi (JP); Kenroku UBUKATA, Hachioji-shi (JP)

(73) Assignee: KONICA MINOLTA, INC., Chiyoda-ku (JP)

(21) Appl. No.: 14/565,244

(22) Filed: Dec. 9, 2014

(30) Foreign Application Priority Data
Dec. 13, 2013 (JP) 2013-257552

(51) Int. Cl. G01T 1/175

(52) U.S. Cl. CPC G01T 1/175

(57) ABSTRACT

A portable radiographic imaging apparatus includes a switching unit that switches power to the apparatus on and off or switches a power consumption mode of the apparatus between imageable mode and power saving mode; an event information managing unit that collects event information about the apparatus or imaging, or accepts input event information; and a storage unit that saves the collected or input event information. The apparatus includes a battery configured to supply power. The switching unit determines whether to perform imaging, based on past event information saved in the storage unit and event information collected or input at present time, and switches the power from on to off or switches the power consumption mode from the imageable mode to the power saving mode, when the switching unit determines that imaging is not performed.

The entire disclosure of Japanese Patent Application No. 2013-257552 filed on Dec. 13, 2013 including description, claims, drawings, and abstract are incorporated herein by reference in its entirety.

### BACKGROUND OF THE INVENTION

1. Field of the Invention

The present invention relates to a portable radiographic imaging apparatus and a radiographic imaging system.

2. Description of the Related Art

As a radiographic imaging apparatus, a radiographic imaging apparatus using an FPD (Flat Panel Detector) is known. Conventionally, a radiographic imaging apparatus is configured as a so-called dedicated machine type in which the radiographic imaging apparatus is integrally formed with a supporting table. However, in recent years, a portable (also called cassette, etc.) radiographic imaging apparatus that contains radiation detecting elements, etc., in a casing, thereby being made portable has been developed and put into practical use.

In many cases, a portable radiographic imaging apparatus includes a battery. In that case, if the power of the battery is wastefully consumed, then the number of times imaging can be performed on a single charge decreases. Hence, the radiographic imaging apparatus needs to be frequently charged, resulting in that the work efficiency of imaging decreases and a radiation technologist or the like which is a user needs to frequently charge the apparatus during the interval between imaging and imaging. Thus, the user finds the radiographic imaging apparatus inconvenient. In view of this, in order not to wastefully consume power, there is known, for example, a radiographic imaging apparatus configured such that, when imaging is not performed for a certain period of time, the power consumption mode is automatically switched to sleep mode with low power consumption.

In addition, for example, JP 2005-3756 A proposes a cassette radiographic imaging apparatus configured to suppress power supply to read circuits, etc., when it is determined, based on, for example, a signal from a handle hold detecting unit provided to a handle portion of the cassette radiographic-imaging apparatus, that an operator such as a radiation technologist is holding the handle of the cassette radiographic imaging apparatus and thus imaging using the radiographic imaging apparatus is not being performed (i.e., in an unused state). This configuration enables to reduce power consumption.

However, in the radiographic imaging apparatus described in JP 2005-3756 A, it is not always easy to determine whether imaging is performed or the apparatus is left without being used for imaging after the operator such as a radiation technologist removes his/her hand from the handle. Hence, there is a possibility that despite the fact that the radiographic imaging apparatus is being left, a state in which power is supplied to the read circuits, etc., may continue for at least a certain period of time, which may result in wasteful power consumption. Accordingly, there is a demand that the radiographic imaging apparatus should be able to more accurately suppress power consumption.

### SUMMARY OF THE INVENTION

The present invention is made in view of the above-described problem, and an object of the present invention is to provide a portable radiographic imaging apparatus and a radiographic imaging system that are capable of accurately suppressing wasteful power consumption in accordance with an operator's (radiation technologist, etc.) actual usage state, etc.

To achieve at least one of the above-mentioned objects, according to an aspect, a portable radiographic imaging apparatus including a plurality of radiation detecting elements arranged two-dimensionally reflecting one aspect of the present invention comprises: a switching unit configured to be able to switch power to the apparatus on and off or switch a power consumption mode of the apparatus between imageable mode where imaging can be performed and power saving mode where an amount of power consumption is smaller than that for the imageable mode but imaging cannot be performed; an event information managing unit configured to collect event information about the apparatus or imaging, or accepts input event information; and a storage unit configured to save the collected or input event information, wherein the apparatus includes a battery configured to supply power, and the switching unit determines whether to perform imaging, based on past event information saved in the storage unit and event information collected or input at present time, and switches the power from on to off or switches the power consumption mode from the imageable mode to the power saving mode, when the switching unit determines that imaging is not performed.

In addition, to achieve at least one of the above-mentioned objects, according to an aspect, a radiographic imaging system reflecting one aspect of the present invention comprises: a portable radiographic imaging apparatus including: a plurality of radiation detecting elements arranged two-dimensionally; a switching unit configured to be able to switch power to the apparatus on and off or switch a power consumption mode of the apparatus between imageable mode where imaging can be performed and power saving mode where an amount of power consumption is smaller than that for the imageable mode but imaging cannot be performed; an event information managing unit configured to collect event information about the apparatus or imaging, or accepts input event information; a battery configured to supply power to each function unit; and a communicating unit configured to perform communication with an external source; and a console or a management apparatus including a storage unit configured to be able to save the event information collected by the event information managing unit of the radiographic imaging apparatus or input to the event information managing unit, wherein the console or the management apparatus determines whether to perform imaging, based on past event information saved in the storage unit and event information collected by the event information managing unit of the radiographic imaging apparatus or input to the event information managing unit and transmitted thereto from the event information managing unit at present time, and instructs the switching unit of the radiographic imaging apparatus to switch the power to the radiographic imaging apparatus from on to off or switch the power consumption mode of the radiographic imaging apparatus from the imageable mode to the power saving mode, when the console or the management apparatus determines that imaging is not performed, and the switching unit of the radiographic imaging apparatus switches the power to the radiographic imaging apparatus from on to off or switches the power consumption mode of the radiographic imaging apparatus from the imageable mode to the power saving mode, based on the instruction from the console or the management apparatus.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective view showing an external appearance of a portable radiographic imaging apparatus according to an embodiment of the present invention;

FIG. 2 is a block diagram showing an equivalent circuit of the portable radiographic imaging apparatus;

FIG. 3 is a diagram showing a configuration example of a radiographic imaging system set up in an imaging room, etc.;

FIG. 4 is a diagram showing a configuration example of a radiographic imaging system set up on a ward round cart and a portable terminal carried by an operator;

FIG. 5 is a diagram showing an example of a configuration for suppressing the power consumption of the radiographic imaging apparatus according to the embodiment;

FIG. 6 is a diagram showing an example of imaging order information; and

FIG. 7 is a diagram showing a configuration example of a radiographic imaging system for when a plurality of imaging rooms are provided, etc.

### DESCRIPTION OF THE PREFERRED EMBODIMENTS

Hereinafter, an embodiment of the present invention will be described with reference to the drawings. However, the scope of the invention is not limited to the illustrated examples.

An embodiment of a portable radiographic imaging apparatus and a radiographic imaging system according to the present invention will be described below with reference to the drawings.

Note that in the following the portable radiographic imaging apparatus may be simply referred to as a radiographic imaging apparatus. Note also that in the following, as the radiographic imaging apparatus, a so-called indirect radiographic imaging apparatus will be described that includes a scintillator, etc., and converts emitted radiation into an electromagnetic wave with another wavelength such as visible light and irradiates radiation detecting elements with the magnetic wave; however, the present invention can also be applied to a so-called direct radiographic imaging apparatus that directly detects radiation with radiation detecting elements without using a scintillator, etc.

[Portable Radiographic Imaging Apparatus]

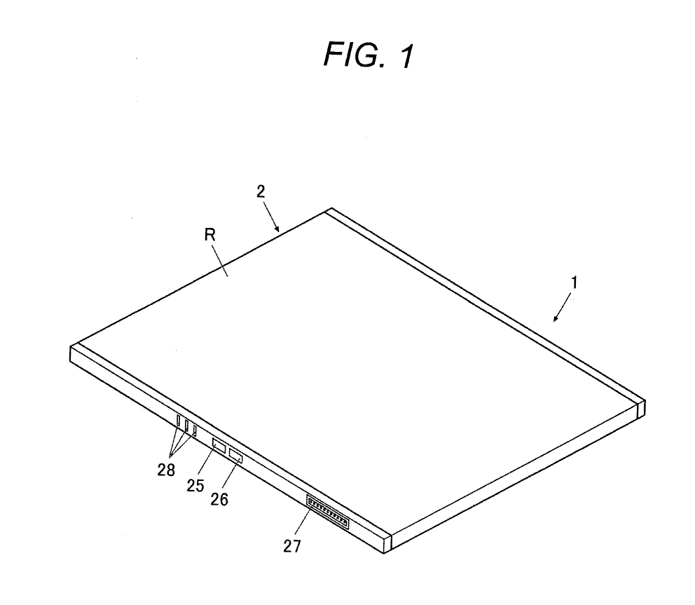

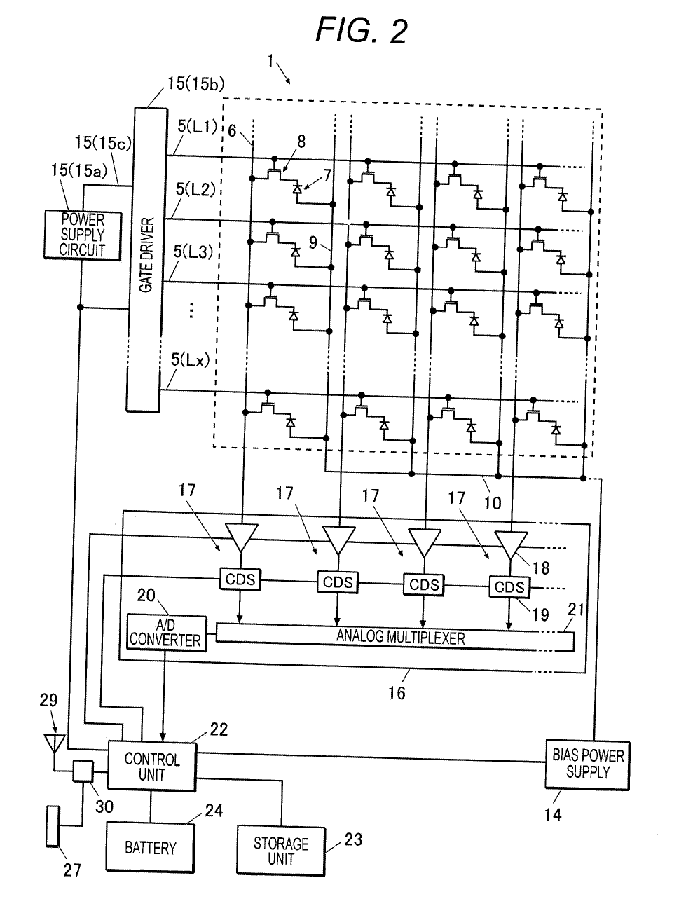

FIG. 1 is a perspective view showing an external appearance of a portable radiographic imaging apparatus according to an embodiment of the present invention. In the present embodiment, a radiographic imaging apparatus 1 is configured such that radiation detecting elements 7, etc., which will be described later, are contained in a casing 2. The casing 2 has a power supply switch 25, a switching switch 26, a connector 27, an indicator 28, etc., disposed on one side thereof. In addition, in the present embodiment, though not shown, an antenna 29 (see FIG. 2 which will be described later) for performing wireless communication with an external source is provided, for example, on the opposite side of the casing 2. Note that when the radiographic imaging apparatus 1 performs communication with an external source by a wireless scheme, the radiographic imaging apparatus 1 uses the antenna 29, and when the radiographic imaging apparatus 1 performs communication with an external source by a wired scheme, the radiographic imaging apparatus 1 performs communication by connecting a cable which is not shown to the connector 27.

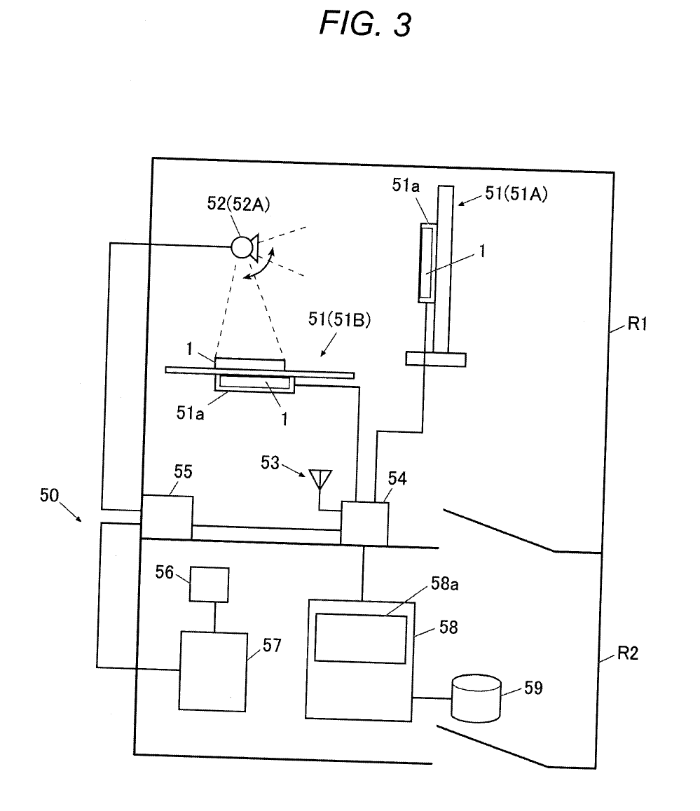

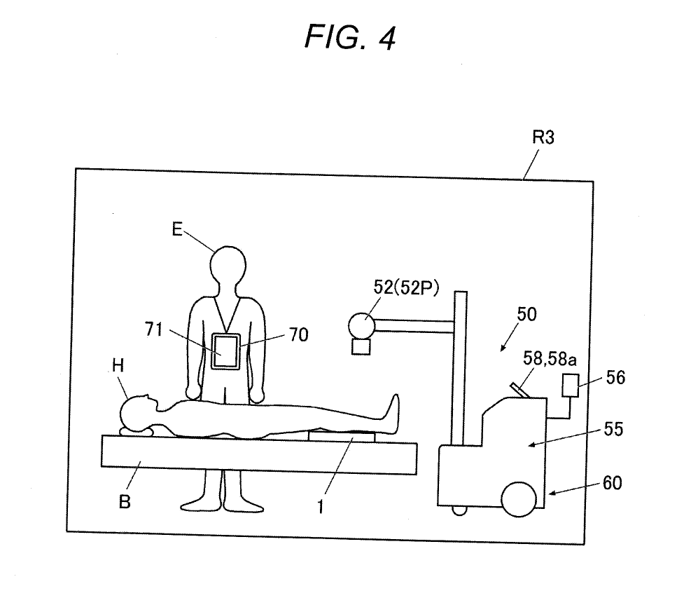

FIG. 2 is a block diagram showing an equivalent circuit of the portable radiographic imaging apparatus. As shown in FIG. 2, in the radiographic imaging apparatus 1, a plurality of radiation detecting elements 7 are arranged two-dimensionally (in a matrix form) on a sensor substrate which is not shown. Each radiation detecting element 7 generates an electric charge according to the amount of radiation which is irradiated by a radiation source 52 of a radiation generating apparatus 55 (described later) (see FIGS. 3 and 4) and passes through a subject which is not shown. A bias line 9 is connected to each radiation detecting element 7. The bias line 9 is connected to a connection 10. The connection 10 is connected to a bias power supply 14. A reverse bias voltage is applied to each radiation detecting element 7 from the bias power supply 14 through a corresponding bias line 9, etc.

A thin film transistor (hereinafter, referred to as a TFT) 8 is connected as a switching element to each radiation detecting element 7. The TFT 8 is connected to a signal line 6. Ina scanning drive unit 15, anon-voltage and an off-voltage are supplied to a gate driver 15b from a power supply circuit 15a through a wiring line 15c. The gate driver 15b switches a voltage to be applied to lines L1 to Lx of scanning lines 5 between an on-voltage and an off-voltage. Each TFT 8 is placed in an on state when an on-voltage is applied thereto through a corresponding scanning line 5, and allows an electric charge accumulated in a corresponding radiation detecting element 7 to be emitted to a corresponding signal line 6. In addition, when an off-voltage is applied to the TFT 8 through the scanning line 5, the TFT 8 is placed in an off state and cuts off the conduction between the radiation detecting element 7 and the signal line 6.

A plurality of read circuits 17 are provided in a read IC 16. The signal lines 6 are connected to the read circuits 17, respectively. An electric charge emitted from a radiation detecting element 7 flows into a corresponding read circuit 17 through a corresponding signal line 6, and an amplifier circuit 18 outputs a voltage value according to the amount of the electric charge flowing thereinto. Then, a correlated double sampling circuit (described as “CDS” in FIG. 2) 19 reads the voltage value output from the amplifier circuit 18, as analog-value image data D and outputs the image data D to the downstream side. Then, the output image data D is sequentially transmitted to an A/D converter 20 through an analog multiplexer 21 and is sequentially converted by the A/D converter 20 into digital-value image data D. Then, the image data D is output to a storage unit 23 and is sequentially saved.

A control unit 22 is composed of a computer in which a CPU (Central Processing Unit), a ROM (Read Only Memory), a RAM (Random Access Memory), an input/output interface, etc., are connected to a bus, an FPGA (Field Programmable Gate Array), or the like, which is not shown. The control unit 22 may be composed of a dedicated control circuit. The storage unit 23 composed of an SRAM (Static RAM), an SDRAM (Synchronous DRAM), or the like, is connected to the control unit 22. In addition, a communicating unit 30 that performs communication with an external source through the antenna 29 or the connector 27 by a wireless scheme or a wired scheme is connected to the control unit 22. Furthermore, a battery 24 that supplies required power to function units such as the scanning drive unit 15, the read circuits 17, the storage unit 23, and the bias power supply 14 is connected to the control unit 22.

In the present embodiment, as will be described later, the control unit 22 also functions as a switching unit and an event information managing unit. Note that in the following description the control unit 22 is represented as a switching unit 22A when functioning as the switching unit, and as an event information managing unit 22B when functioning as the event information managing unit; however, the switching unit and the event information managing unit can also be composed of circuits, etc., different than the control unit 22.

In addition, in the present embodiment, as will be described later, the switching unit 22A can switch the power to the radiographic imaging apparatus 1 on and off. The event information managing unit 22B collects event information about the apparatus or imaging or accepts an input of event information even when the radiographic imaging apparatus 1 is in a power-off state. Hence, even when the radiographic imaging apparatus 1 is in a power-off state, power is supplied at all times to the control unit 22 serving as the switching unit 22A and the event information managing unit 22B, from the battery 24 or another battery with a smaller capacity than the battery 24, etc. Note that needless to say the radiographic imaging apparatus 1 is configured such that the amount of power consumption when the radiographic imaging apparatus 1 is in a power-off state is reduced to a minimum.

In addition, in the present embodiment, as will be described later, the switching unit 22A can switch the power consumption mode of the radiographic imaging apparatus 1 between at least imageable mode where power is supplied to function units including the scanning drive unit 15 and the read circuits 17 to allow to perform imaging, and power saving mode where the amount of power consumption is smaller than that for imageable mode, but imaging cannot be performed.

Note that in the present embodiment the radiographic imaging apparatus 1 is configured to further have, as power saving mode, standby mode where current passes through the function units as with imageable mode, but a reset process for the radiation detecting elements 7 is not performed, and sleep mode where power is not supplied to the scanning drive unit 15, the read circuits 17, etc., but power is only supplied to necessary function units such as the communicating unit 30 so that when there is transmission of a signal from an external source, for example, the signal can be received. In this case, in standby mode the amount of power consumption is larger than that for sleep mode, but is smaller than that for imageable mode.

In addition, it is also possible to provide, as power saving mode, modes with various power consumption levels, in addition to standby mode and sleep mode. A method of setting a mode in the power consumption mode is determined as appropriate. Furthermore, a configuration for suppressing the power consumption of the radiographic imaging apparatus 1, etc., will be described after describing a radiographic imaging system.

[Radiographic Imaging System]

A configuration example of a radiographic imaging system 50 according to the present embodiment will be described. FIG. 3 is a diagram showing a configuration example of the radiographic imaging system 50 according to the present embodiment. FIG. 3 shows the case in which the radiographic imaging system 50 is set up in an imaging room R1, etc. In the imaging room R1, bucky apparatuses 51 are placed. Each bucky apparatus 51 can mount the above-described radiographic imaging apparatus 1 on a cassette holding unit 51a thereof. Note that although FIG. 3 shows the case in which a bucky apparatus for standing position imaging 51A and a bucky apparatus for supine position imaging 51B are placed as the bucky apparatuses 51, only one of the bucky apparatuses 51 may be provided. Note also that, as shown in FIG. 3, the imaging room R1 is provided with at least one radiation source 52A of a radiation generating apparatus 55 that irradiates the radiographic imaging apparatuses 1 mounted on the bucky apparatuses 51 with radiation through a subject.

In addition, the imaging room R1 is provided with a relay 54 having an access point 53 for relaying, for example, communication between apparatuses in the imaging room R1 and apparatuses outside the imaging room R1. In addition, the relay 54 is connected to the radiation generating apparatus 55 and a console 58. The relay 54 includes therein a converter (not shown) that converts, for example, a signal for LAN (Local Area Network) communication transmitted from the radiographic imaging apparatus 1, the console 58, etc., to the radiation generating apparatus 55 into a signal for the radiation generating apparatus 55, for example, and also performs conversion the other way around. In addition, in order that an appropriate amount of radiation can be irradiated by the radiation source 52, the radiation generating apparatus 55 performs various control on the radiation source 52, such as setting of tube current, irradiation time, etc.

In the present embodiment, a front room (also referred to as an operation room, etc.) R2 is provided with an operator's console 57 for the radiation generating apparatus 55. The operator's console 57 is provided with an exposure switch 56 which is operated by an operator such as a radiation technologist to instruct the radiation generating apparatus 55 to start irradiation of radiation, etc. The exposure switch 56 is provided with a button which is not shown. When the operator such as a radiation technologist performs a first-level operation (i.e., a so-called half-press operation) on the button of the exposure switch 56, the radiation generating apparatus 55 activates the radiation source 52. Then, when the operator performs a second-level operation (i.e., a so-called full-press operation) on the button of the exposure switch 56, the radiation generating apparatus 55 allows the radiation source 52 to irradiate radiation. Note that whether there is a coordination between the radiation generating apparatus 55 and the radiographic imaging apparatus 1 when radiation is irradiated by the radiation generating apparatus 55, etc., will be described later.

In addition, as shown in FIG. 3, in the present embodiment, the console 58 composed of a computer, etc., is provided in the front room R2. Note that the console 58 can also be provided in the imaging room R1 or outside the front room R2 or another room and thus is placed in an appropriate location. The console 58 is provided with a display unit 58a configured to include a CRT (Cathode Ray Tube), an LCD (Liquid Crystal Display), or the like. In addition, the console 58 is provided with an input unit such as a mouse and a keyboard which are not shown. In addition, a storage unit 59 composed of an HDD (Hard Disk Drive) or the like is connected to or included in the console 58. Furthermore, though not shown, an HIS (Hospital Information System), an RIS (Radiology Information System), a PACS (Picture Archiving and Communication System), etc., are connected to the console 58 through, for example, a network such as a LAN.

Meanwhile, as shown in FIG. 4, the radiographic imaging apparatus 1 can also be used alone, so to speak, without mounted on a bucky apparatus 51. FIG. 4 is a diagram showing a configuration example of the radiographic imaging system 50 set up on a ward round cart 60. For example, when a patient H cannot get out of a bed B in a hospital room R3 and thus cannot go to an imaging room R1 such as that shown in FIG. 3, as shown in FIG. 4, the radiographic imaging apparatus 1 and the ward round cart 60 are brought into the hospital room R3 and the radiographic imaging apparatus 1 can be used by inserting it between the bed B and the body of the patient H or placing it on the body of the patient H.

In addition, when the radiographic imaging apparatus 1 is used in the hospital room R3, etc., as shown in FIG. 4, a radiation generating apparatus 55 is brought into the hospital room R3, mounted on the ward round cart 60, instead of the above-described radiation generating apparatus 55 installed in the imaging room R1. In addition, in this case, a portable radiation source 52P that can appropriately change the irradiation direction of radiation, etc., is mounted on the ward round cart 60. In addition, a console 58 composed of, for example, a portable computer such as a notebook personal computer, and the like are mounted on the ward round cart 60. Note that, though not shown in FIG. 4, the ward round cart 60 is configured to also have the access point 53, the relay 54, etc., shown in FIG. 3, mounted thereon.

Note that, though this also applies to the case of imaging in the imaging room R1 shown in FIG. 3, it is also possible that a portable terminal 70 is allowed to have the same function as the console 58, e.g., as shown in FIG. 4, an operator E such as a radiation technologist carries the portable terminal 70 having a display unit 71 and an image displayed on a display unit 58a of the console 58 is also displayed on the display unit 71 of the portable terminal 70. By such a configuration, the operator such as a radiation technologist can check the image on the display unit 71 of the portable terminal 70 carried thereby, without the need to go over to the console 58 each time. Thus, it is convenient to the operator.

In addition, in the present embodiment, the console 58 also functions as an image processing apparatus that performs, when image data D and the like are transmitted from the radiographic imaging apparatus 1, precise image processing such as gain correction, defective pixel correction, and a grayscale process according to an imaging body part, based on the image data D and the like, and thereby crates a radiographic image.

[For Whether there is a Coordination Between the Radiographic Imaging Apparatus and the Radiation Generating Apparatus]

Note that, as is well known, when imaging is performed by the radiation generating apparatus 55 irradiating the radiographic imaging apparatus 1 with radiation as described above, imaging may be performed while the radiation generating apparatus 55 and the radiographic imaging apparatus 1 coordinate with each other by establishing an interface between the radiation generating apparatus 55 and the radiographic imaging apparatus 1. Note that this scheme is hereinafter referred to as a coordination scheme (also referred to as a synchronous scheme, etc.).

In the case of the coordination scheme, before the radiographic imaging apparatus 1 performs imaging, the radiographic imaging apparatus 1 starts a reset process for the radiation detecting elements 7 where electric charges are removed from the radiation detecting elements 7, and at the time when the operator such as a radiation technologist performs a second-level operation (i.e., a full-press operation) on the exposure switch 56, an irradiation start signal is transmitted to the radiographic imaging apparatus 1 directly or through the console 58. The radiographic imaging apparatus 1 stops the reset process at the time when, for example, the reset process for the radiation detecting elements 7 being performed at that time has been completed for one frame (i.e., up to the last line Lx of the scanning line 5). Then, an off-voltage is applied to the TFTs 8 through the corresponding scanning lines 5 from the scanning drive unit 15 to place the TFTs 8 in an off state, transitioning to an electric charge accumulation state where electric charges generated in the radiation detecting elements 7 are accumulated in the radiation detecting elements 7. Then, the radiographic imaging apparatus 1 transmits an interlock cancellation signal to the radiation generating apparatus 55, by which the radiographic imaging apparatus 1 is irradiated with radiation by the radiation generating apparatus 55. In the coordination scheme, imaging is performed by the radiographic imaging apparatus 1 and the radiation generating apparatus 55 thus coordinating with each other.

Note that, when the radiographic imaging apparatus 1 is configured to be able to switch the power consumption mode between imageable mode and power saving mode (standby mode and sleep mode) as described above, for example, conventionally, there is a case configured as follows. Specifically, when the operator such as a radiation technologist operates the console 58 to wake up the radiographic imaging apparatus 1 from sleep mode, in an initial wake-up state the radiographic imaging apparatus 1 transitions to standby mode to allow function units to perform necessary processes such as initial setting. Then, at the time when the initial operation is completed, the radiographic imaging apparatus 1 switches the power consumption mode to imageable mode and performs a reset process for the radiation detecting elements 7 as described above, for imaging.

However, instead of this, for example, the radiation generating apparatus 55 is configured to transmit a signal to the radiographic imaging apparatus 1 at the time when a first-level operation (i.e., a half-press operation) of the exposure switch 56 is performed. Alternatively, the radiation generating apparatus 55 is configured to mount thereon a detecting unit that detects whether a half-press operation, etc., are performed on the exposure switch 56 (see, for example, a stroke detecting unit 60 in JP 2011-104083 A), and transmit a signal to the radiographic imaging apparatus 1 from the detecting unit at the time when a first-level operation (i.e., a half-press operation) of the exposure switch 56 is performed. On the other hand, the radiographic imaging apparatus 1 can be configured such that, even if the radiographic imaging apparatus 1 wakes up from sleep mode by receiving a wake-up signal from the console 58 and completes initial operation as described above, the radiographic imaging apparatus 1 does not switch the power consumption mode to imageable mode but continues standby mode. Then, only when, as described above, the radiographic imaging apparatus 1 receives from the radiation generating apparatus 55 or the detecting unit a signal indicating that a first-level operation of the exposure switch 56 has been performed, the radiographic imaging apparatus 1 switches the power consumption mode to imageable mode and starts a reset process for the radiation detecting elements 7.

Then, if a required number of reset processes have not been performed at the time when a second-level operation (i.e., a full-press operation) is performed on the exposure switch 56 and the above-described irradiation start signal is transmitted from the radiation generating apparatus 55, then at the time when the required number of reset processes are completed, the radiographic imaging apparatus 1 transmits an interlock cancellation signal as described above, and transitions to an electric charge accumulation state.

In addition, it is also possible to configure the radiographic imaging apparatus 1 such that, when the required number of reset processes are completed before an irradiation start signal is transmitted from the radiation generating apparatus 55, the radiographic imaging apparatus 1 stops the reset process at the time when the required number of reset processes are completed, to transition to an electric charge accumulation state, and transmits an interlock cancellation signal to the radiation generating apparatus 55 immediately when the above-described signal is transmitted. In addition, it is also possible to configure the radiographic imaging apparatus 1 to continuously perform a reset process even after the required number of reset processes are completed. Then, in this case, as with the above, at the time when a reset process being performed at the time when an irradiation start signal is transmitted is completed for one frame, the radiographic imaging apparatus 1 stops the reset process and transitions to an electric charge accumulation state, and at the same time, transmits an interlock cancellation signal to the radiation generating apparatus 55.

At any rate, by the above-described configurations, the power consumption of the radiographic imaging apparatus 1 can be accurately suppressed and reduced. Specifically, there may be a case in which, even when the operator such as a radiation technologist wakes up the radiographic imaging apparatus 1, the radiographic imaging apparatus 1 is not immediately irradiated with radiation by the radiation generating apparatus 55, and it takes time to perform, for example, positioning between the radiographic imaging apparatus 1 and a subject. In conventional cases, a reset process for the radiation detecting elements 7 is performed even during positioning, etc. However, as described above, by not performing a reset process during such a period and by starting a reset process at the time when a first-level operation is performed on the exposure switch 56, a reset process for the radiation detecting elements 7 is prevented from being performed for a long period of time, enabling to suppress the power consumption of the radiographic imaging apparatus 1. Then, as described above, by performing at least a required number of reset processes before starting irradiation of the radiographic imaging apparatus 1 with radiation, imaging can be performed with electric charges accurately removed from the radiation detecting elements 7, enabling to accurately perform imaging.

Meanwhile, when imaging is performed by the radiation generating apparatus 55 irradiating the radiographic imaging apparatus 1 with radiation, imaging may be performed by the radiographic imaging apparatus 1 itself detecting a start of irradiation with radiation, instead of the radiographic imaging apparatus 1 and the radiation generating apparatus 55 coordinating with each other because an interface cannot be established between the radiation generating apparatus 55 and the radiographic imaging apparatus 1 or the interface is not established as described above. Note that this scheme is hereinafter referred to as a non-coordination scheme (also referred to as an asynchronous scheme, etc.).

In the case of the non-coordination scheme, it is possible to configure the radiographic imaging apparatus 1 such that, for example, a radiation sensor or the like is mounted on the radiographic imaging apparatus 1 or a current detecting unit that detects a current flowing through the bias lines 9 and the connection 10 (see FIG. 2) is provided to the radiographic imaging apparatus 1 (see, for example, JP 2009-219538 A), so that the radiographic imaging apparatus 1 itself can detect a start of irradiation with radiation, based on an output value from the radiation sensor, the current detecting unit, or the like. In addition, it is also possible to configure the radiographic imaging apparatus 1 such that the radiographic imaging apparatus 1 performs, before starting irradiation with radiation, the process of reading leakage data which is data corresponding to electric charges leaking from the radiation detecting elements 7 through the TFTs 8 (see, for example, WO 2011/135917 A) or performs, before starting irradiation with radiation, the process of reading data for irradiation start detection from the radiation detecting elements 7 in the same manner as the process of reading image data D (see, for example, WO 2011/152093 A), so that the radiographic imaging apparatus 1 itself can detect a start of irradiation with radiation, based on the read leakage data or data for irradiation start detection or a value calculated from those data, or the like.

In the case of the non-coordination scheme, the radiographic imaging apparatus 1 is configured to place the TFTs 8 in an off state at the time when a start of irradiation with radiation is detected, to transition to an electric charge accumulation state. Hence, since in the non-coordination scheme, too, electric charges which are generated in the radiation detecting elements 7 by irradiation with radiation can be accurately accumulated in the radiation detecting elements 7, radiographic imaging can be accurately performed in the non-coordination scheme, too. Note that the present invention is applied to both of the case of imaging by the coordination scheme and the case of imaging by the non-coordination scheme.

[For a Configuration for Suppressing the Power Consumption of the Radiographic Imaging Apparatus, Etc.]

A configuration for suppressing the power consumption of the radiographic imaging apparatus 1 according to the present embodiment, etc., will be described below using some examples. In addition, the actions of the radiographic imaging apparatus 1 according to the present embodiment will also be described together.

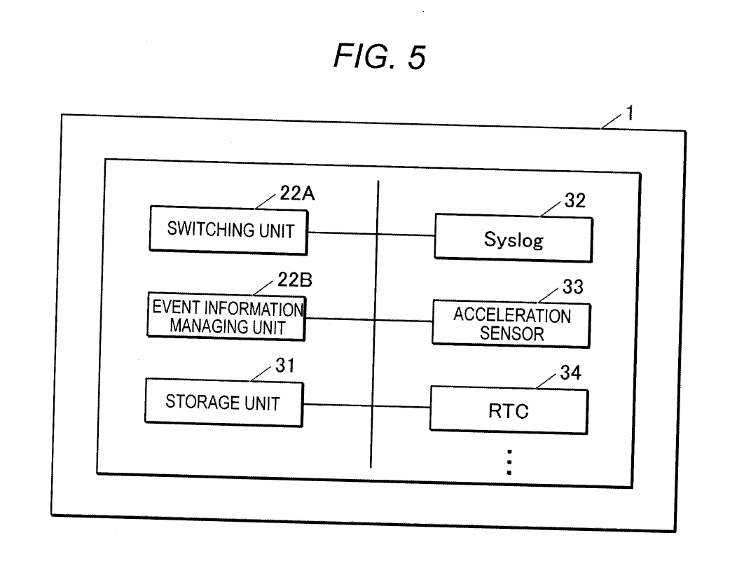

In the present embodiment, as shown in FIG. 5, the radiographic imaging apparatus 1 includes a switching unit 22A that can switch the power to the apparatus on and off and switch the power consumption mode of the apparatus between imageable mode and power saving mode (standby mode and sleep mode). Note that power saving mode does not need to have two types, sleep mode and standby mode, and may have one type of mode. In addition, it is also possible that power saving mode has three or more types of modes.

In addition, as shown in FIG. 5, the radiographic imaging apparatus 1 includes an event information managing unit 22B that collects event information about the radiographic imaging apparatus 1 or imaging, or accepts event information input from an external apparatus or the operator such as a radiation technologist; and a storage unit 31 that can save the event information thus collected or input. Note that the storage unit in this case may be configured to use the above-described storage unit 23 (see FIG. 2), etc., or can also be configured to use the RAM in the control unit 22, etc., or can also be configured as a storage unit different than those storage units. In addition, the event information managing unit 22B collects event information or accepts an input of event information by, for example, using the function of syslog 32 as necessary.

Then, in the present embodiment, the switching unit 22A determines whether to perform imaging, based on past event information which is collected or whose input is accepted by the event information managing unit 22B and saved in the storage unit 31, and event information collected or input at the present time. Then, if it is determined that imaging is not performed, the power to the radiographic imaging apparatus 1 is switched from on to off or the power consumption mode is switched from imageable mode to power saving mode.

Note that in the present embodiment the switching unit 22A of the radiographic imaging apparatus 1 analyzes pieces of past event information which are collected or whose inputs are accepted by the event information managing unit 22B and saved in the storage unit 31 or learns, so to speak, based on those pieces of past event information. Then, as a result, when event information is collected or event information is input at the present time, the switching unit 22A derives a situation taken place when event information corresponding to or similar to the event information collected or input at the present time has been collected or input in the past, from the above-described analysis, learning, etc., and then, determines whether to perform imaging.

Therefore, even if the following description includes a portion that can be read as: the switching unit 22A of the radiographic imaging apparatus 1 is programmed in advance such that the switching unit 22A determines whether or not to perform imaging when a situation is given where past event information is saved in the storage unit 31 and given event information is collected or input at the present time, or the switching unit 22A is configured in advance in such a manner, that description does not conform to the spirit of the present invention. The present invention only claims that, as described above, the switching unit 22A of the radiographic imaging apparatus 1 determines itself whether to perform imaging, based on analysis, learning, etc.

Note that in that case, too, needless to say, in order that the switching unit 22A of the radiographic imaging apparatus 1 can eventually make an appropriate determination, a user sets conditions, directions, etc. Specifically, for example, the user sets conditions, directions, etc., for the contents of event information saved in the storage unit 31 by the event information managing unit 22B or contents or the like to be analyzed by the switching unit 22A (i.e., for example, an imaging body part or age included in imaging order information in a configuration example which will be described later).

In addition, although the following description assumes that the switching unit 22A is configured to be able to perform control of both of the power on/off switching and power consumption mode switching of the radiographic imaging apparatus 1, the switching unit 22A does not need to be configured to perform both controls and may be configured to perform only one of the controls. In addition, the switching unit 22A may also be configured to include switching control other than the above-described two controls and to be able to switch the magnitude of the amount of power consumption by that switching control, too. The present invention is applied to all of the above-described cases. Furthermore, in the present embodiment, too, as with conventional cases, when imaging is not performed for a certain period of time with the power consumption mode set to imageable mode, the power consumption mode is automatically switched to power saving mode.

### Configuration Example 1

In configuration example 1 for suppressing power consumption, as shown in FIG. 5, the radiographic imaging apparatus 1 is configured to include an acceleration sensor 33 and a clock (Real Time Clock, hereinafter abbreviated as RTC) 34. In addition, the event information managing unit 22B collects at least an output value from the acceleration sensor 33, i.e., information on acceleration applied to the apparatus and detected by the acceleration sensor 33, which is one of event information about the radiographic imaging apparatus 1, and saves the output value in the above-described storage unit 31 in association with a real time output from the RTC 34. In addition, in this configuration example 1, the event information managing unit 22B also collects information on the power on/off switching of the radiographic imaging apparatus 1 performed by the operator such as a radiation technologist and information on the power consumption mode switching of the radiographic imaging apparatus 1 performed by the operator such as a radiation technologist, and saves those pieces of information in the storage unit 31 in association with real times.

The operator such as a radiation technologist normally turns on the power to the radiographic imaging apparatus 1 when bringing the radiographic imaging apparatus 1 into the imaging room R1 (see FIG. 3). When all imaging is done, the operator turns off the power to the radiographic imaging apparatus 1 and brings the radiographic imaging apparatus 1 out into the front room R2 or a storage area which is not shown. Then, every time such operation is repeated, the event information managing unit 22B associates information on acceleration detected by the acceleration sensor 33 with a real time output from the RTC 34 and saves those pieces of information as event information in the storage unit 31. If there is power on/off switching of the radiographic imaging apparatus 1 or power consumption mode switching performed by the operator such as a radiation technologist, the event information managing unit 22B also collects those pieces of information and saves them in the storage unit 31. Then, when such operation is repeated several times, information on acceleration applied to the radiographic imaging apparatus 1 which is detected by the acceleration sensor 33 and information on the power on/off or power consumption mode switching of the radiographic imaging apparatus 1 are accumulated in the storage unit 31.

Now, analysis of these pieces of information is considered. In this case, since those pieces of information are associated with real times output from the RTC 34, for example, those pieces of information are arranged chronologically. In addition, a distance that the radiographic imaging apparatus 1 has been moved (has been carried) can also be calculated based on acceleration applied to the radiographic imaging apparatus 1. Taking a chronological look at the movement and power on/off switching (or power consumption mode switching) of the radiographic imaging apparatus 1, it can be seen that there is a pattern, e.g., when the radiographic imaging apparatus 1 is moved a predetermined distance, the power to the radiographic imaging apparatus 1 is turned on (the power consumption mode is switched to imageable mode), and when the power to the radiographic imaging apparatus 1 is turned off (or the power consumption mode is switched to power saving mode), the radiographic imaging apparatus 1 is moved a predetermined distance. There may be another pattern, e.g., after the power to the radiographic imaging apparatus 1 is turned on, the radiographic imaging apparatus 1 is moved, or after the radiographic imaging apparatus 1 is moved a predetermined distance, the power is turned off.

By analyzing this pattern, it can be seen that the location where the power to the radiographic imaging apparatus 1 is turned on, i.e., the location where the power to the radiographic imaging apparatus 1 is turned on after the radiographic imaging apparatus 1 has been moved the predetermined distance or the destination to which the radiographic imaging apparatus 1 has been moved by the predetermined distance after the power is turned on, is the imaging room R1 (see FIG. 3), i.e., a location where imaging using the apparatus is performed. In addition, it can be seen that the destination to which the radiographic imaging apparatus 1 has been moved by the predetermined distance after the power is turned off or the location where the power to the radiographic imaging apparatus 1 is turned off after the radiographic imaging apparatus 1 has been moved the predetermined distance is the front room R2 or the storage area, i.e., a location where imaging using the apparatus is not performed.

Hence, for example, the switching unit 22A determines in what state the radiographic imaging apparatus 1 is in at the present time, based on the above-described pattern determined from these pieces of past event information, i.e., information on acceleration applied to the apparatus, etc., which are saved in the storage unit 31, and the state of the radiographic imaging apparatus 1 determined from event information collected by the event information managing unit 22B at the present time. Specifically, when it is determined from acceleration detected by the acceleration sensor 33 that the radiographic imaging apparatus 1 is moving, it is determined whether the radiographic imaging apparatus 1 is heading to the imaging room R1 or is coming out of the imaging room R1. In addition, if the radiographic imaging apparatus 1 is at rest, then it is determined whether the radiographic imaging apparatus 1 is in the imaging room R1 or in the front room R2 or the storage area.

Then, when it is determined in this determination process that the radiographic imaging apparatus 1 has come out of the imaging room R1 or is in a location other than the imaging room R1 such as the front room R2 or the storage area, the switching unit 22A determines that imaging using the radiographic imaging apparatus 1 is not performed. Then, when it is determined that imaging is not performed, the switching unit 22A switches the power to the radiographic imaging apparatus 1 from on to off or switches the power consumption mode from imageable mode to power saving mode (e.g., sleep mode).

By such a configuration, when the switching unit 22A determines the state of the radiographic imaging apparatus 1, i.e., where the radiographic imaging apparatus 1 is at the present time, based on at least acceleration detected by the acceleration sensor 33, and accordingly, determines that imaging using the radiographic imaging apparatus 1 is not performed, the switching unit 22A can accurately turn off the power to the radiographic imaging apparatus 1 or can accurately switch the power consumption mode to power saving mode. In addition, even if the operator such as a radiation technologist forgets to perform an operation to, for example, turn off the power to the radiographic imaging apparatus 1, the power to the radiographic imaging apparatus 1 is automatically switched to off by the switching unit 22A. Hence, in the radiographic imaging apparatus 1, wasteful power consumption can be accurately suppressed in accordance with an operator (radiation technologist, etc.)'s actual usage state, etc.

On the other hand, when the switching unit 22A determines that the radiographic imaging apparatus 1 is in the imaging room R1 at the present time, based on at least acceleration detected by the acceleration sensor 33, and accordingly, determines that imaging using the radiographic imaging apparatus 1 is performed, the switching unit 22A can switch the power to the radiographic imaging apparatus 1 to on or can switch the power consumption mode from power saving mode to imageable mode. In addition, even if the operator such as a radiation technologist forgets to perform an operation to, for example, turn on the power to the radiographic imaging apparatus 1, the power to the radiographic imaging apparatus 1 is automatically switched to on by the switching unit 22A. Hence, by such a configuration, the power to the radiographic imaging apparatus 1 is turned on or the power consumption mode is accurately switched to imageable mode, enabling to switch the state of the radiographic imaging apparatus 1 to a state in which the radiographic imaging apparatus 1 can be used for imaging.

Note that, in the case of this configuration example 1, information on a real time does not necessarily need to be associated with, for example, information on acceleration detected by the acceleration sensor 33. Namely, in this configuration example 1, the RTC 34 is not an essential component. Note also that, in contrast, although the following configuration examples do not mention again a real time measured by the RTC 34, it is also possible to save each event information in the storage unit 31 in association with information on a real time.

### Configuration Example 2

In addition, by saving, as described above, information on acceleration detected by the acceleration sensor 33 and information on the power on/off switching or power consumption mode switching of the radiographic imaging apparatus 1 in association with real times obtained by the RTC 34, it can be seen during what hours the radiographic imaging apparatus 1 is used, by analyzing information on the real times associated with the pieces of information. Specifically, for example, it can be seen that there is a tendency that imaging is performed using the radiographic imaging apparatus 1 from 9 am to 12 noon, imaging is not performed during 12 noon to 1 pm, imaging is performed during daytime hours after 1 pm, and imaging is not performed almost at all in the nighttime.

Hence, in this configuration example 2, for example, the event information managing unit 22B collects information indicating that the radiographic imaging apparatus 1 has been irradiated with radiation, and associates the information with information on a real time measured by the RTC 34 and saves in the storage unit 31 those pieces of information as event information about imaging. Note that for the information indicating that the radiographic imaging apparatus 1 has been irradiated with radiation, for example, in both of the cases of the above-described coordination scheme and non-coordination scheme, the fact that the control unit 22 places the TFTs 8 in an off state and transitions to an electric charge accumulation state can be collected as the above-described information. Note that it is also possible to collect other information such as information indicating that an interlock cancellation signal has been transmitted from the radiographic imaging apparatus 1 to the radiation generating apparatus 55 (in the case of the coordination scheme) or information indicating that the control unit 22 has detected a start of irradiation with radiation (in the case of the non-coordination scheme), as the information indicating that the radiographic imaging apparatus 1 has been irradiated with radiation.

Then, the switching unit 22A determines, for example, the hours during which the radiographic imaging apparatus 1 is used for imaging or the hours during which the radiographic imaging apparatus 1 is not used for imaging, from pieces of past event information which are saved in the storage unit 31 and associated with real times (i.e., in this case, pieces of information on irradiation with radiation associated with real times). Then, when a current real time output from the RTC 34 is in the hours during which the radiographic imaging apparatus 1 is not used, it is determined that imaging is not performed and thus the switching unit 22A switches the power to the radiographic imaging apparatus 1 from on to off or switches the power consumption mode from imageable mode to power saving mode.

By such a configuration, when the current real time is in the hours which are determined by the switching unit 22A from the past usage conditions and during which the radiographic imaging apparatus 1 is not used for imaging, it is determined that imaging is not performed, and thus, the power to the radiographic imaging apparatus 1 can be accurately turned off or the power consumption mode can be accurately switched to power saving mode. In addition, even if the operator such as a radiation technologist forgets to perform an operation to, for example, turn off the power to the radiographic imaging apparatus 1, the power to the radiographic imaging apparatus 1 is automatically switched to off by the switching unit 22A. Hence, in the radiographic imaging apparatus 1, wasteful power consumption can be accurately suppressed in accordance with an operator (radiation technologist, etc.)'s actual usage state, etc.

On the other hand, when the current real time is in the hours which are determined by the switching unit 22A from the past usage conditions and during which the radiographic imaging apparatus 1 is used for imaging, it is determined that imaging is performed, and thus, the process of switching the power or the power consumption mode is performed, e.g., the power to the radiographic imaging apparatus 1 is accurately switched to on. By this configuration, even if the operator such as a radiation technologist forgets to perform an operation to, for example, turn on the power to the radiographic imaging apparatus 1, the power to the radiographic imaging apparatus 1 is automatically switched to on by the switching unit 22A. Hence, the state of the radiographic imaging apparatus 1 can be accurately switched to a state in which the radiographic imaging apparatus 1 can be used for imaging.

### Configuration Example 3

Note that once the power consumption mode of the radiographic imaging apparatus 1 has been switched to sleep mode, it may take time for the radiographic imaging apparatus 1 to actually become imageable after the power consumption mode is switched back to imageable mode. In that regard, in the case of standby mode where current passes through the function units as with imageable mode, but a reset process for the radiation detecting elements 7 is not performed, by performing switching from standby mode to imageable mode, imaging can be performed immediately. However, in standby mode the amount of power consumption is larger than that for sleep mode.

Meanwhile, according to the study of the inventors of the present invention, it has been found that, when, with the power consumption mode of the radiographic imaging apparatus 1 being switched to sleep mode, current is allowed to pass through a panel unit having formed therein the scanning lines 5, the signal lines 6, the radiation detecting elements 7, the TFTs 8 (see FIG. 2), etc., at certain time intervals for a predetermined period of time, thereafter, the time required for the radiographic imaging apparatus 1 to actually become imageable after the power consumption mode of the radiographic imaging apparatus 1 is switched from sleep mode to imageable mode can be significantly reduced (see Japanese Patent Application No. 2013-207343). Note that this power consumption mode where current is allowed to periodically pass through the panel unit in sleep mode is hereinafter referred to as periodic current passage mode, as a mode different than sleep mode. Note also that in periodic current passage mode the amount of power consumption is larger than that for sleep mode, but is remarkably smaller than that for imageable mode or standby mode.

Hence, it is also possible, for example, to more minutely perform, for example, switching of the power consumption mode by hours which is shown in configuration example 2. Specifically, for example, in a facility such as a hospital, since there are many patients in the morning, even if there is no imaging scheduled to be performed next at the present time, it is highly likely that a patient comes, ending up performing imaging. Hence, during those hours with such a high frequency of use of the radiographic imaging apparatus 1, when the power consumption mode of the radiographic imaging apparatus 1 is switched from imageable mode to a mode with lower power consumption, it is desirable to switch the power consumption mode of the radiographic imaging apparatus 1 to standby mode where imaging can be performed immediately when the power consumption mode is switched back to imageable mode.

In addition, in the afternoon there may be less patients compared to in the morning. However, even if there is no imaging scheduled to be performed next at the present time, it is likely that a patient comes, ending up performing imaging. Hence, when the power consumption mode of the radiographic imaging apparatus 1 is switched from imageable mode to a mode with lower power consumption mode during those hours with such a medium frequency of use of the radiographic imaging apparatus 1, if the power consumption mode is switched to standby mode, the amount of power consumption is large, and if the power consumption mode is switched to sleep mode, then when a patient comes the patient cannot be dealt with immediately. Thus, it is desirable to switch the power consumption mode to the above-described periodic current passage mode.

Furthermore, in the nighttime, unless there is an emergency case, radiographic imaging is normally not performed. Hence, during those hours with such a low frequency of use of the radiographic imaging apparatus 1, it is desirable to switch the power consumption mode of the radiographic imaging apparatus 1 to sleep mode or to switch the power to the radiographic imaging apparatus 1 to off. Note that in the case of a facility, etc., in which radiographic imaging is not performed almost at all not only in the nighttime but also in the afternoon, for example, it is also possible that, as with the above-described case, the power consumption mode of the radiographic imaging apparatus 1 is switched to sleep mode or the power to the radiographic imaging apparatus 1 is switched to off. By the above-described configuration, wasteful power consumption can be accurately suppressed in accordance with the actual usage state of the radiographic imaging apparatus 1, etc.

### Configuration Example 4

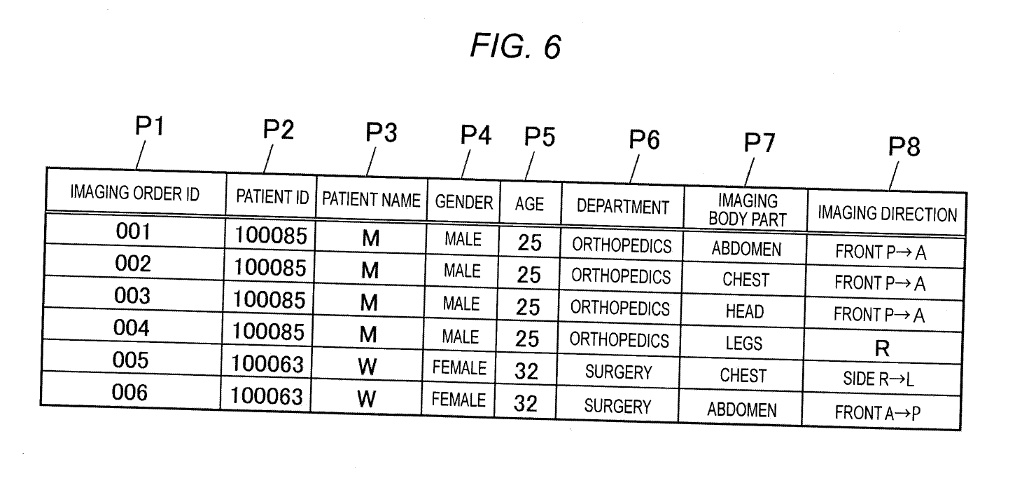

Meanwhile, when imaging is performed, in many cases, imaging order information specifying, for example, imaging conditions about imaging (“imaging body part” P7, “imaging direction” P8, etc.) and patient information (“patient ID” P2, “gender” P4, “age” P5, etc.) such as that shown in FIG. 6, for example, is created in advance. Then, when, for example, imaging of a plurality of imaging body parts such as the abdomen, the chest, and the head is performed on one person to be imaged (i.e., a patent in this case), a plurality of pieces of imaging order information are created for the same patient, like those pieces of information whose “imaging order ID” P1 is “001” to “004” in FIG. 6. In addition, when imaging where imaging of the same imaging body part (e.g., the chest) is performed on a plurality of persons to be imaged, like the case of group health screening for children, for example, though not shown, a plurality of pieces of imaging order information specifying the same imaging body part are created for the plurality of different persons to be imaged.

Then, when a plurality of pieces of imaging order information specify the imaging of a plurality of imaging body parts of one patient, like the former one, if imaging is performed according to these pieces of imaging order information, then since positioning between the patient and the radiographic imaging apparatus 1, movement of the patient, and the like, are performed every imaging, a certain amount of time interval occurs between imaging and the next imaging. On the other hand, when a plurality of pieces of imaging order information specify the imaging of the same imaging body part of a plurality of persons to be imaged, like group health screening which is the latter one, if imaging is performed according to these pieces of imaging order information, then imaging is performed one after another and thus it is experienced that the time interval between imaging and the next imaging is short.

Hence, in such a case, by saving in the storage unit 31 these pieces of imaging order information which are transmitted from the console 58 before imaging, and analyzing a relationship between these pieces of past imaging order information and a time interval between imaging and the next imaging, it can be seen that there is a tendency that, when the pieces of imaging order information specify the imaging of a plurality of imaging body parts of one patient, the time interval between imaging and the next imaging is long, and when the pieces of imaging order information specify the imaging of the same imaging body part of a plurality of persons to be imaged, like group health screening, the time interval between imaging and the next imaging is short.

Hence, in configuration example 4, the event information managing unit 22B of the radiographic imaging apparatus 1 saves in the storage unit 31 these pieces of imaging order information which are transmitted and input thereto from the console 58 every imaging, as event information about imaging, and the switching unit 22A performs the above-described analysis based on those pieces of past event information. Namely, in configuration example 4, imaging order information input to the radiographic imaging apparatus 1 serves as event information. Then, when the switching unit 22A determines, based on imaging order information transmitted from the console 58 before the current imaging, that the imaging to be performed from now on is imaging where imaging of a plurality of imaging body parts is performed on one person to be imaged, the switching unit 22A switches the power consumption mode of the radiographic imaging apparatus 1 from imageable mode to standby mode every imaging. By such a configuration, the power consumption mode of the radiographic imaging apparatus 1 can be automatically switched from imageable mode to standby mode while positioning between the patient and the radiographic imaging apparatus 1, movement of the patient, and the like, are performed between imaging and the next imaging, enabling to accurately suppress the power consumption of the radiographic imaging apparatus 1.

When the switching unit 22A determines, based on imaging order information transmitted from the console 58 before the current imaging, that the imaging to be performed from now on is imaging where imaging of the same imaging body part is performed on a plurality of persons to be imaged, like group health screening, the switching unit 22A does not switch the power consumption mode from imageable mode to standby mode every imaging, but leaves imageable mode as it is. By such a configuration, when the time interval between imaging and the next imaging is short, there is no need to perform the operation of switching the power consumption mode of the radiographic imaging apparatus 1 each time imaging is performed, enabling to promptly and accurately perform imaging.

Note that in this case, when imaging of a plurality of imaging body parts is performed on one person to be imaged, if the power consumption mode of the radiographic imaging apparatus 1 is switched to sleep mode, then as described above, it may take time for the radiographic imaging apparatus 1 to actually become imageable after the power consumption mode is switched back to imageable mode. In that regard, in the case of standby mode, by performing switching from standby mode to imageable mode, imaging can be performed immediately. Hence, to achieve suppression of power consumption, in the above-described case, it is preferred that the power consumption mode be switched between imageable mode and standby mode, instead of switching the power consumption mode between imageable mode and sleep mode.

### Configuration Example 5

There is a case in which the operator such as a radiation technologist switches or does not switch the power consumption mode of the radiographic imaging apparatus 1 from imageable mode to standby mode, depending on the imaging body part. Specifically, when the imaging body part is the chest of a patient, for example, since there is body motion from breathing, in order that irradiation with radiation can be performed at any timing that the operator such as a radiation technologist thinks appropriate, in many cases, normally, the operator wants the radiographic imaging apparatus 1 to be always ready for irradiation with radiation. Hence, in many cases, imaging is performed with the power consumption mode of the radiographic imaging apparatus 1 remaining as imageable mode even during positioning (i.e., with the power consumption mode being not switched to standby mode, etc.).

On the other hand, when the imaging body part is a hand, the legs, or the like, since there is no body motion from breathing, the operator such as a radiation technologist performs irradiation with radiation after the power consumption mode of the radiographic imaging apparatus 1 is switched from standby mode to imageable mode. Thus, the operator may think that it is better to switch the power consumption mode to standby mode during positioning in order to reduce power consumption. Hence, a case may arise in which depending on the operator, the power consumption mode of the radiographic imaging apparatus 1 is switched or is not switched from imageable mode to standby mode, according to the imaging body part.

Hence, in this configuration example 5, too, imaging order information input to the radiographic imaging apparatus 1 is used as event information about imaging. When the switching unit 22A of the radiographic imaging apparatus 1 determines, based on, for example, “imaging body part” P7 (see FIG. 6) specified in each of pieces of past imaging order information which are input and saved in the storage unit 31 as described above and “imaging body part” P7 specified in imaging order information input at the present time, that “imaging body part” P7 specified in imaging order information corresponding to imaging to be performed from now on is imaging performed by going through a state in which the power consumption mode is switched to standby mode, like the above-described case of a hand, the legs, or the like, the switching unit 22A switches the power consumption mode from imageable mode to standby mode. On the other hand, when the switching unit 22A determines that “imaging body part” P7 specified in imaging order information corresponding to imaging to be performed from now on is imaging performed in imageable mode without going through a state in which the power consumption mode is switched to standby mode, like the above-described case of the chest, or the like, the switching unit 22A does not switch the power consumption mode from imageable mode to standby mode, and imaging is performed with the power consumption mode remaining as imageable mode.

By such a configuration, the following is made possible. Specifically, there are a case in which the operator such as a radiation technologist performs imaging with the power consumption mode of the radiographic imaging apparatus 1 remaining as imageable mode (the case of the chest or the like) and a case in which the operator performs imaging such that after temporarily switching the power consumption mode to standby mode, the operator switches the power consumption mode back to imageable mode (in the case of a hand, the legs, or the like), according to the body part of a patient to be imaged, i.e., the imaging body part. In accordance with those cases, the switching unit 22A can accurately switch or does not switch the power consumption mode of the radiographic imaging apparatus 1, according to the imaging body part. Hence, in the radiographic imaging apparatus 1, wasteful power consumption can be accurately suppressed in accordance with an operator (radiation technologist, etc.)'s actual usage state, etc.

### Configuration Example 6

There may be a case in which whether to perform imaging with the power consumption mode of the radiographic imaging apparatus 1 remaining as imageable mode or perform imaging such that after temporarily switching the power consumption mode to standby mode, the operator switches the power consumption mode back to imageable mode, which is determined according to whether a patient (a person to be imaged) is an adult or an infant may vary by the determination made by the operator such as a radiation technologist. Specifically, when the patient is an adult, since he/she can stay still, so to speak, the operator such as a radiation technologist may think that it is better to switch the power consumption mode to standby mode during positioning in order to reduce power consumption. On the other hand, when the patient is an infant, since he/she may not be able to stay still, the operator may want to perform irradiation with radiation at the right timing with the power consumption mode of the radiographic imaging apparatus 1 remaining as imageable mode, depending on the imaging body part. Hence, a case may arise in which depending on the operator, the power consumption mode of the radiographic imaging apparatus 1 is switched or is not switched from imageable mode to standby mode, according to patient age.

Hence, in this configuration example 6, too, as in the case of the above-described configuration example 5, imaging order information input to the radiographic imaging apparatus 1 is used as event information about imaging. When the switching unit 22A of the radiographic imaging apparatus 1 determines, based on, for example, information on “age” P5 specified in each of pieces of past imaging order information which are input and saved in the storage unit 31 as described above and “age” P5 specified in imaging order information input at the present time (i.e., upon the current imaging), that “age” P5 specified in imaging order information corresponding to the current imaging is imaging performed by going through a state in which the power consumption mode is switched to standby mode, like the case indicating that the patient is an adult, the switching unit 22A switches the power consumption mode from imageable mode to standby mode. On the other hand, when the switching unit 22A determines that “age” P5 specified in imaging order information corresponding to imaging to be performed from now on is imaging performed in imageable mode without going through a state in which the power consumption mode is switched to standby mode, like the case indicating that the patient is an infant, the switching unit 22A does not switch the power consumption mode from imageable mode to standby mode, and imaging is performed with the power consumption mode remaining as imageable mode.

By such a configuration, the following is made possible. Specifically, there are a case in which the operator such as a radiation technologist performs imaging with the power consumption mode of the radiographic imaging apparatus 1 remaining as imageable mode (the case of an infant) and a case in which the operator performs imaging such that after temporarily switching the power consumption mode to standby mode, the operator switches the power consumption mode back to imageable mode (in the case of an adult), according to the age of a patient to be imaged, i.e., whether the patient is an adult who can stay still or an infant who cannot stay still. The switching unit 22A of the radiographic imaging apparatus 1 accurately switches or does not switch the power consumption mode of the radiographic imaging apparatus 1, according to patient age. Hence, in the radiographic imaging apparatus 1, wasteful power consumption can be accurately suppressed in accordance with an operator (radiation technologist, etc.)'s actual usage state, etc.

### Configuration Example 7

Meanwhile, the radiographic imaging apparatus 1 may be used for imaging by being mounted on the bucky apparatus 51 in the imaging room R1 as shown in FIG. 3, or may be used by being bought into the hospital room R3 together with the ward round cart 60 and used alone, so to speak, instead of being mounted on the bucky apparatus 51 or the like, such that the radiographic imaging apparatus 1 is inserted between the bed B and the body of the patient H or is placed on the body of the patient H as shown in FIG. 4, for example. In the case of a so-called dedicated machine type radiographic imaging apparatus installed in the imaging room R1, the radiographic imaging apparatus can only be used in the imaging room R1. However, in the case of the portable radiographic imaging apparatus 1 such as that in the present embodiment, the radiographic imaging apparatus 1 has the advantage of being able to be used for imaging anywhere, including the imaging room R1 and the hospital room R3.

When imaging is performed using the radiographic imaging apparatus 1 in the imaging room R1, positioning between the radiographic imaging apparatus 1 mounted on the bucky apparatus 51 and an imaging body part of a patient which is a subject can be relatively speedily performed and imaging can be relatively speedily performed. Thus, even if imaging is performed with the power consumption mode of the radiographic imaging apparatus 1 remaining as imageable mode (i.e., without switching the power consumption mode to power saving mode), the radiographic imaging apparatus 1 does not consume much power. On the other hand, when imaging is performed by, for example, bringing the radiographic imaging apparatus 1 into the hospital room R3 together with the ward round cart 60, it may take time to perform positioning between the radiographic imaging apparatus 1 and an imaging body part of a patient. In such a case, if the power consumption mode remains as imageable mode, then the radiographic imaging apparatus 1 may consume a relatively large amount of power. Hence, when imaging is performed by bringing the radiographic imaging apparatus 1 together with the ward round cart 60, it is better to temporarily switch the power consumption mode of the radiographic imaging apparatus 1 to power saving mode.

When the radiographic imaging apparatus 1 is brought into the imaging room R1 or when the radiographic imaging apparatus 1 is brought into the hospital room R3 together with the ward round cart 60, for example, identification information of the imaging room R1 or the ward round cart 60 is transmitted in advance to the radiographic imaging apparatus 1 from the console 58 associated with the imaging room R1 or the console 58 on the ward round cart 60, for example. Even when identification information of the imaging room R1 or the ward round cart 60, or the like, is not transmitted, at least, for example, identification information (an SSID or the like) of the access point 53 in the imaging room R1 (see FIG. 3) or an access point 53 of the ward round cart 60 (not shown in FIG. 4) is transmitted in advance from the console 58 or is input by the operator such as a radiation technologist or is acquired by the radiographic imaging apparatus 1 itself from the access point 53.

Hence, the event information managing unit 22B of the radiographic imaging apparatus 1 collects the identification information of the imaging room R1 or the ward round cart 60 and the identification information of the access point 53, as event information about imaging (i.e., information about whether imaging is performed in the imaging room R1 or is performed using the ward round cart 60), or accepts input event information. Note that, when the event information managing unit 22B of the radiographic imaging apparatus 1 collects event information in the form of identification information of the access point 53 or accepts an input of event information, the event information managing unit 22B determines, from the identification information of the access point 53 which is collected or whose input is accepted, identification information of the imaging room R1 or the ward round cart 60 associated with the identification information of the access point 53, and manages the determined identification information as the above-described event information. Namely, in this configuration example 7, the identification information of the imaging room R1 or the ward round cart 60 serves as event information about imaging.

Then, every time imaging is performed, the event information managing unit 22B saves in the storage unit 31 identification information of the imaging room R1 or the ward round cart 60 where the imaging is performed, as event information. Then, the switching unit 22A of the radiographic imaging apparatus 1 analyzes imaging conditions in the pieces of event information saved in the storage unit 31. As a result, it can be seen that there is a tendency that, as described above, in the imaging room R1 imaging is relatively speedily performed after the radiographic imaging apparatus 1 is mounted on the bucky apparatus 51; on the other hand, when imaging is performed by bringing the radiographic imaging apparatus 1 into the hospital room R3 together with the ward round cart 60, it takes time to perform positioning between the radiographic imaging apparatus 1 and an imaging body part of a patient and thus it takes a relatively long time before imaging is performed.

Hence, as described above, at the time before imaging, the switching unit 22A collects or accepts an input of information about whether the imaging is performed in the imaging room R1 or is performed using the ward round cart 60. If it is determined that the imaging is performed using the ward round cart 60, based on past event information saved in the storage unit 31 and the above-described event information which is collected or whose input is accepted at the present time, the switching unit 22A temporarily switches the power consumption mode of the radiographic imaging apparatus 1 from imageable mode to power saving mode. By such a configuration, when it takes time to perform positioning between the radiographic imaging apparatus 1 and an imaging body part of a patient in imaging using the ward round cart 60, the power consumption mode of the radiographic imaging apparatus 1 can be automatically and temporarily switched from imageable mode to power saving mode, enabling to accurately suppress the power consumption of the radiographic imaging apparatus 1.

### Configuration Example 7-1

Note that, when a plurality of imaging rooms R1 are provided or a plurality of ward round carts 60 are disposed in a facility such as a hospital, as described above, the switching unit 22A of the radiographic imaging apparatus 1 collects or accepts an input of identification information of an imaging room R1 or award round cart 60 or an access point 53. By this, it can be known not only whether imaging is performed in the imaging room R1 or is performed using the ward round cart 60, but also in which imaging room R1 the imaging is performed or which ward round cart 60 is used for the imaging.

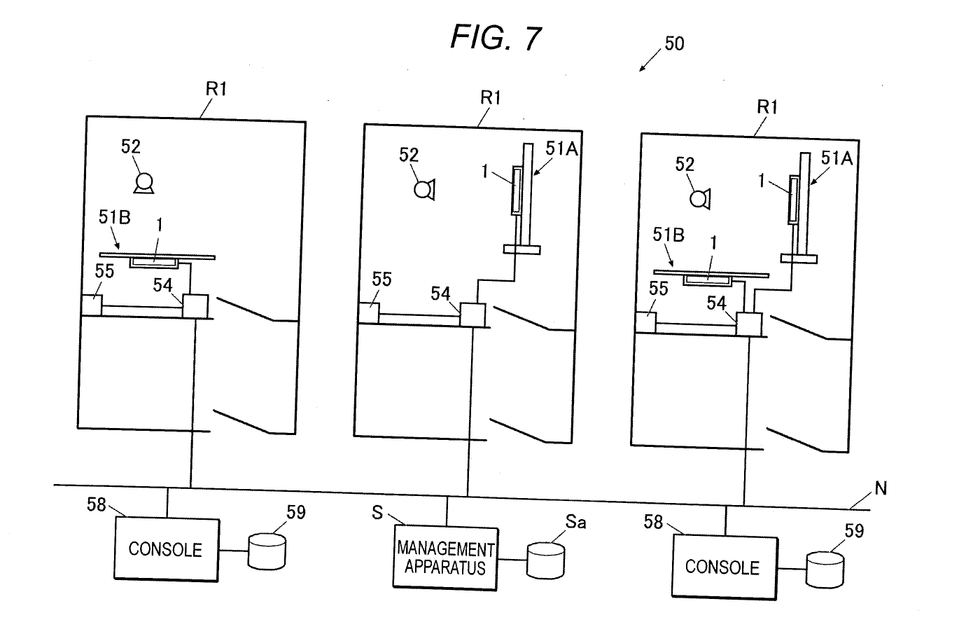

When, for example, a plurality of imaging rooms R1 are provided as shown in FIG. 7, the imaging environment may vary between the individual imaging rooms R1, e.g., an imaging room R1 has only one of a bucky apparatus for standing position imaging 51A and a bucky apparatus for supine position imaging 51B, or has a radiation source 52 shared between a bucky apparatus for standing position imaging 51A and a bucky apparatus for supine position imaging 51B, or has a bucky apparatus for standing position imaging 51A and a bucky apparatus for supine position imaging 51B provided separately. In addition, when imaging is performed using a ward round cart 60, too, the operations performed for imaging or the procedure of the operations or the time required for each operation may vary between ward round carts 60. Again, the actual imaging state may vary between the individual ward round carts 60.

Hence, the switching unit 22A of the radiographic imaging apparatus 1 can also be configured to determine, for each imaging room R1 or ward round cart 60 used for imaging, whether the power consumption mode of the radiographic imaging apparatus 1 is temporarily switched from imageable mode to power saving mode upon imaging or imaging is performed with the power consumption mode remaining as imageable mode, based on pieces of past event information which are collected or whose inputs are accepted by the event information managing unit 22B and saved in the storage unit 31 and information on an imaging room R1 or a ward round cart 60 used for the current imaging. Note that, in FIG. 7, N indicates a network that connects the imaging rooms R1 to consoles 58. Note also that a management apparatus S is composed of, for example, a computer such as a server, and will be described later.

### Configuration Example 8

Meanwhile, the above-described configuration can be used for estimation as to whether a subsequent imaging schedule can be completed with the remaining voltage of the battery 24 of the radiographic imaging apparatus 1 (see FIG. 2). Specifically, though not shown, the radiographic imaging apparatus 1 is configured to include a voltage detecting unit that detects a voltage V of the battery 24. The event information managing unit 22B collects information on the voltage V of the battery 24 from the voltage detecting unit and, in the case of performing imaging, information on the imaging and saves those pieces of information in the storage unit 31. Namely, in the case of this configuration example 8, the information on the voltage V of the battery 24 detected by the voltage detecting unit and the information indicating that imaging has been performed serve as event information about the radiographic imaging apparatus 1.

Then, the switching unit 22A of the radiographic imaging apparatus 1 determines, at all times or when the remaining amount of the voltage V of the battery 24 is less than or equal to a set threshold value, for example, and thus is small, whether the remaining imaging schedule can be completed with the voltage V of the battery 24 remaining at the present time, from past information on the voltage V of the battery 24 saved in the storage unit 31 and the information indicating that imaging has been performed. If it is determined that the remaining imaging schedule cannot be completed with the voltage V of the battery 24 remaining at the present time, such a fact is notified to a user by, for example, displaying it on the radiographic imaging apparatus 1 or the console 58, or allowing the indicator 28 of the radiographic imaging apparatus 1 (see FIG. 1) to light up or blink, or generating sound.

By such a configuration, before the remaining amount of the voltage V of the battery 24 is gone and accordingly the remaining imaging schedule becomes unable to be completed, the operator such as a radiation technologist can be accurately alerted to charge the battery 24 of the radiographic imaging apparatus 1. In according with the notification, the operator such as a radiation technologist can charge the battery 24 of the radiographic imaging apparatus 1 using changeover time between patients, break time, etc., enabling to accurately prevent the occurrence of an event where the remaining amount of the voltage V of the battery 24 is gone and accordingly the remaining imaging schedule cannot be completed.

Note that, when the radiographic imaging apparatus 1 is configured as described above, it is also possible that, for example, information on the speed of charging (i.e., the rate of rise of the voltage V of the battery 24 per unit time) is collected every time the battery 24 of the radiographic imaging apparatus 1 is charged and information indicating, for example, how long it takes to sufficiently charge the battery 24 to complete the remaining imaging schedule is also notified by display, for example, based on the remaining amount of the voltage V of the battery 24 at the present time. By such a configuration, the operator such as a radiation technologist can accurately complete the remaining imaging schedule by charging the battery 24 of the radiographic imaging apparatus 1 for at least the notified period of time.

### Configuration Example 9

Note that the above-described configuration examples 1 to 8 describe the case in which the switching unit 22A of the radiographic imaging apparatus 1 determines itself whether to perform imaging, based on the past event information saved in the storage unit 31 and event information which is collected or whose input is accepted at the present time, and if it is determined that imaging is not performed, the switching unit 22A switches the power to the radiographic imaging apparatus 1 from on to off or switches the power consumption mode of the radiographic imaging apparatus 1 from imageable mode to power saving mode. However, it is also possible that, instead of the switching unit 22A of the radiographic imaging apparatus 1 making a determination, event information which is collected or whose input is accepted by the event information managing unit 22B of the radiographic imaging apparatus 1 is transmitted to the console 58 (see FIGS. 3 and 4) or the management apparatus S (see FIG. 7) by wireless communication or wired communication, and the console 58 or the management apparatus S makes a determination. Namely, it is also possible that the above-described information collection/input process, determination process, etc., are performed by the entire radiographic imaging system 50 including the radiographic imaging apparatus 1, the console 58, etc. (see FIGS. 3, 4, and 7), instead of being performed only by the radiographic imaging apparatus 1.

Specifically, when event information which is collected or whose input is accepted by the event information managing unit 22B of the radiographic imaging apparatus 1 is transmitted to the console 58 or the management apparatus S, the console 58 or the management apparatus S saves the event information in the storage unit 59 (see FIG. 3) or a storage unit Sa (see FIG. 7). Then, the console 58 or the management apparatus S determines whether to perform imaging, as in the above-described configuration examples 1 to 8, based on the past event information saved in the storage unit 59 or Sa and event information which is collected or whose input is accepted by the event information managing unit 22B of the radiographic imaging apparatus 1 and transmitted thereto from the event information managing unit 22B at the present time. If it is determined that imaging is not performed, the console 58 or the management apparatus S transmits a signal instructing the switching unit 22A of the radiographic imaging apparatus 1 to switch the power to the radiographic imaging apparatus 1 from on to off or switch the power consumption mode of the radiographic imaging apparatus 1 from imageable mode to power saving mode. The switching unit 22A of the radiographic imaging apparatus 1 is configured to perform the process of switching the power to the radiographic imaging apparatus 1 from on to off or switching the power consumption mode of the radiographic imaging apparatus 1 from imageable mode to power saving mode, in response to the instruction.

By such a configuration, as in the case of the above-described configuration examples 1 to 8, in the radiographic imaging apparatus 1, wasteful power consumption can be accurately suppressed in accordance with an operator (radiation technologist, etc.)'s actual usage state, etc. In addition, instead of performing the above-described information collection/input process, determination process, etc., by the switching unit 22A and the event information managing unit 22B of the radiographic imaging apparatus 1 like the above-described configuration examples 1 to 8, the above-described determination process, etc., are performed by the entire radiographic imaging system 50 including the radiographic imaging apparatus 1, the console 58, etc. Hence, since the radiographic imaging apparatus 1 does not need to perform all of the above-described information collection/input process, determination process, etc., the power consumption of the radiographic imaging apparatus 1 can be accordingly more accurately suppressed. Then, the processing load on the switching unit 22A of the radiographic imaging apparatus 1 (the control unit 22 in the case of the present embodiment) can be further reduced.

### EFFECTS

As described above, according to the radiographic imaging apparatus 1 and the radiographic imaging system 50 according to the present embodiment, the switching unit 22A of the radiographic imaging apparatus 1 determines whether to perform imaging, based on the past event information saved in the storage unit 31, 59, or Sa and event information which is collected or whose input is accepted by the event information managing unit 22B of the radiographic imaging apparatus 1 at the present time. If it is determined that imaging is not performed, the switching unit 22A switches the power to the radiographic imaging apparatus 1 from on to off or switches the power consumption mode from imageable mode to power saving mode. Thus, wasteful power consumption of the battery 24 of the radiographic imaging apparatus 1 can be accurately suppressed in accordance with an operator (radiation technologist, etc.)'s actual usage state, etc.

Hence, the number of times imaging can be performed on a single charge of the battery 24 in the portable radiographic imaging apparatus 1 can be increased, enabling to further improve the work efficiency of imaging in imaging using the radiographic imaging apparatus 1. Therefore, the radiographic imaging apparatus 1 and the radiographic imaging system 50 including the radiographic imaging apparatus 1 are convenient to the operator such as a radiation technologist.

Note that in many cases how to use the radiographic imaging apparatus 1 varies depending on the operator such as a radiation technologist, i.e., the user. Hence, it is also possible that the above-described information collection/input process performed by the event information managing unit 22B and the above-described determination process as to whether to perform imaging, based on the past event information saved in the storage unit 31 and event information collected or input at the present time, which is performed by the switching unit 22A, are performed individually on a user-by-user basis, i.e., on an operator-by-operator basis, the user using the radiographic imaging apparatus 1. In this case, for example, every time the radiographic imaging apparatus 1 is used, identification information such as a user ID assigned to each user is input to the radiographic imaging apparatus 1. Then, the event information managing unit 22B of the radiographic imaging apparatus 1 adds the identification information about the user to event information which is collected or whose input is accepted, and saves the event information in the storage unit 31. Then, in a determination process performed by the switching unit 22A, the switching unit 22A performs the process based on only those pieces of event information having added thereto the identification information about the user using the radiographic imaging apparatus 1 at the present time.

By such a configuration, the power on/off or power consumption mode switching of the radiographic imaging apparatus 1 can be appropriately performed on a user-by-user basis, the user using the radiographic imaging apparatus 1, according to, for example, the habit or expertise of the user or user preferences in regard to the procedure of imaging, etc. Thus, in the radiographic imaging apparatus 1, power consumption can be more accurately suppressed in accordance with the actual usage state for each operator such as a radiation technologist, etc.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A portable radiographic imaging apparatus including a plurality of radiation detecting elements arranged two-dimensionally, the apparatus comprising:
a switching unit configured to be able to switch power to the apparatus on and off or switch a power consumption mode of the apparatus between imageable mode where imaging can be performed and power saving mode where an amount of power consumption is smaller than that for the imageable mode but imaging cannot be performed;
an event information managing unit configured to collect event information about the apparatus or imaging, or accepts input event information; and
a storage unit configured to save the collected or input event information, wherein
the apparatus includes a battery configured to supply power, and
the switching unit
determines whether to perform imaging, based on past event information saved in the storage unit and event information collected or input at present time, and
switches the power from on to off or switches the power consumption mode from the imageable mode to the power saving mode, when the switching unit determines that imaging is not performed.

2. The portable radiographic imaging apparatus according to claim 1, wherein when the switching unit determines that imaging is performed, the switching unit switches the power from off to on or switches the power consumption mode from the power saving mode to the imageable mode.

3. The portable radiographic imaging apparatus according to claim 1, further comprising an acceleration sensor configured to detect acceleration applied to the apparatus, wherein
the event information managing unit collects information on the acceleration from the acceleration sensor and saves the information as the event information in the storage unit,
when the switching unit determines that the apparatus has come out of an imaging room, based on past acceleration detected by the acceleration sensor and saved in the storage unit and acceleration detected by the acceleration sensor at present time, the switching unit determines that imaging is not performed.

4. The portable radiographic imaging apparatus according to claim 1, wherein
the event information managing unit saves input imaging order information as the event information in the storage unit, and
the switching unit
switches the power consumption mode from the imageable mode to the power saving mode for each imaging when the switching unit determines, based on past imaging order information saved in the storage unit and imaging order information input at present time, that imaging to be performed from now on is imaging where imaging of a plurality of imaging body parts is performed on one person to be imaged, but
does not switch the power consumption mode from the imageable mode to the power saving mode for each imaging when the switching unit determines that imaging to be performed from now on is imaging where imaging of a same imaging body part is performed on a plurality of persons to be imaged.

5. The portable radiographic imaging apparatus according to claim 1, wherein
the event information managing unit saves input imaging order information as the event information in the storage unit, and
the switching unit
switches the power consumption mode from the imageable mode to the power saving mode when the switching unit determines, based on imaging body parts or ages of persons to be imaged specified in past imaging order information saved in the storage unit, and an imaging body part or an age of a person to be imaged specified in imaging order information input at present time, that imaging to be performed from now on is imaging performed by going through a state in which the power consumption mode is switched to the power saving mode, but
does not switch the power consumption mode from the imageable mode to the power saving mode when the switching unit determines that imaging to be performed from now on is imaging performed without going through a state in which the power consumption mode is switched to the power saving mode.

6. The portable radiographic imaging apparatus according to claim 1, wherein
the event information managing unit saves information about whether imaging is performed in an imaging room or is performed using a ward round cart, as the event information in the storage unit, and
the switching unit switches the power consumption mode from the imageable mode to the power saving mode when the switching unit determines, based on past information saved in the storage unit and information input at present time, that imaging is performed using the ward round cart.

7. The portable radiographic imaging apparatus according to claim 1, further comprising a voltage detecting unit configured to detect a voltage of the battery, wherein
the event information managing unit collects information on the voltage of the battery from the voltage detecting unit and information indicating that imaging has been performed, and saves the pieces of information as the event information in the storage unit, and
the switching unit
determines, based on past information on voltages of the battery and the information indicating that imaging has been performed and information on a voltage of the battery collected at present time, whether a remaining imaging schedule can be completed with a voltage of the battery remaining at present time, the past information and the information indicating that imaging has been performed being saved in the storage unit, and
notifies, when the switching unit determines that the remaining imaging schedule cannot be completed with the voltage of the battery remaining at the present time, of a fact that the remaining imaging schedule cannot be completed.

8. The portable radiographic imaging apparatus according to claim 1, further comprising a clock configured to measure a real time, wherein
the event information managing unit associates information indicating that the apparatus has been irradiated with radiation with a real time measured by the clock, and saves the information as the event information in the storage unit, and
the switching unit determines hours during which the apparatus is used for imaging, based on pieces of past event information associated with real times and saved in the storage unit, and determines that imaging is not performed when a real time at present time is in hours during which the apparatus is not used.

9. The portable radiographic imaging apparatus according to claim 1, further comprising a clock configured to measure a real time, wherein
the event information managing unit associates the collected or input event information about the apparatus or imaging with a real time measured by the clock, and saves the event information as the event information in the storage unit.

10. A radiographic imaging system comprising:
a portable radiographic imaging apparatus including:
a plurality of radiation detecting elements arranged two-dimensionally;
a switching unit configured to be able to switch power to the apparatus on and off or switch a power consumption mode of the apparatus between imageable mode where imaging can be performed and power saving mode where an amount of power consumption is smaller than that for the imageable mode but imaging cannot be performed;
an event information managing unit configured to collect event information about the apparatus or imaging, or accepts input event information;
a battery configured to supply power to each function unit; and
a communicating unit configured to perform communication with an external source; and
a console or a management apparatus including a storage unit configured to be able to save the event information collected by the event information managing unit of the radiographic imaging apparatus or input to the event information managing unit, wherein
the console or the management apparatus determines whether to perform imaging, based on past event information saved in the storage unit and event information collected by the event information managing unit of the radiographic imaging apparatus or input to the event information managing unit and transmitted thereto from the event information managing unit at present time, and instructs the switching unit of the radiographic imaging apparatus to switch the power to the radiographic imaging apparatus from on to off or switch the power consumption mode of the radiographic imaging apparatus from the imageable mode to the power saving mode, when the console or the management apparatus determines that imaging is not performed, and
the switching unit of the radiographic imaging apparatus switches the power to the radiographic imaging apparatus from on to off or switches the power consumption mode of the radiographic imaging apparatus from the imageable mode to the power saving mode, based on the instruction from the console or the management apparatus.
